(19) United States
(12) Patent Application Publication
(10) Pub. No.: US 2009/0028012 A1
(43) Pub. Date: Jan. 29, 2009

(54) REMOVABLE MEDIUM RECORDING/REPRODUCING DEVICE RECORDING/REPRODUCING OPERATION INHIBITING METHOD, RECORDING OPERATION INHIBITING METHOD, FIRMWARE UPDATE METHOD, AND FILE CONTAINING THE FIRMWARE

(75) Inventors: Tatsuya Yanagida, Ehime (JP); Yorio Takahashi, Ehime (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., Osaka (JP)

(21) Appl. No.: 11/994,096

(22) PCT Filed: Jun. 12, 2006
(86) PCT No.: PCT/JP2006/311747

§ 371 Date: Dec. 27, 2007

(30) Foreign Application Priority Data
Jun. 29, 2005 (JP) 2005-189081

(51) Int. Cl. G11B 5/09

(52) U.S. Cl. 369/47.1

(57) ABSTRACT

Immediately after firmware is installed in a flash ROM (R2), a CPU (C2) erases adjustment value information required for recording in the flash ROM (R2) in response to a command (3), for example, so that in an optical disk device serving as a removable medium recording/reproducing device, the CPU (C2) cannot receive a command relating to recording, thereby inhibiting the recording function.

### TECHNICAL FIELD

The present invention relates to a technique of inhibiting the recording or reproducing operation of a removable medium recording/reproducing device capable of recording or reproduction on multiple kinds of media.

### BACKGROUND ART

In recent years, as removable medium recording/reproducing devices capable of recording or reproduction on multiple kinds of media, for example, as optical disk devices capable of recording or reproduction on optical disks serving as media, recording-type optical disk devices have become mainstream.

The following will describe such a recording-type optical disk device (hereinafter, will be simply referred to as an “optical disk device”) in accordance with the accompanying drawings.

FIG. 1 is an explanatory drawing showing the operational concept of a typical optical disk device. FIG. 1 illustrates the relationship between a flash ROM (R1) for storing software (hereinafter, will be referred to as firmware) installed in the optical disk device and a CPU (C1) for performing the commands of the firmware, in the execution of the firmware. As shown in FIG. 1, the CPU (C1) controls the firmware in the flash ROM (R1) to sequentially perform the commands. The CPU (C1) normally performs, immediately after being turned on or reset, the commands of the firmware from a first command (1). The commands are similarly performed also immediately after the firmware is installed, that is, the commands of the firmware are performed after the installation is completed.

Conventionally, in order to obtain the optimum recording power in combo drives before recording, necessary values are tested in a manufacturing process and an initial value for each drive is stored in a flash ROM (ROM) by executing the aforementioned firmware. In order to obtain the optimum recording power in use by a user, the power is gradually changed from a low power to a high power based on the value, so that the optimum recording power is obtained for a recording medium.

In the case of such optical disk devices, optical disk devices only having the reproducing function may be demanded for business use to prevent the leakage of classified information from individuals. As a matter of course, hardware only having the reproducing function is more advantageous in cost. However, considering the development cost, demand, and so on, the development of hardware for reproducing only is not always advantageous as a whole.

For this reason, drive manufactures are forced to abandon the development of drives for reproducing only in consideration of the decreasing prices and cost of drives. In this case, in an optical disk device serving as hardware having reproducing and recording functions, the recording function can be inhibited by changing firmware installed in the optical disk device. This software is generally stored in a flash memory ROM in the device and can be rewritten by download from a host computer connected to the device.

In the aforementioned optical disk device capable of recording, the following method is used: when the optical disk device capable of recording is changed to a device for reproducing only in response to a user's instruction to change the device to a device for reproducing only, that is, an instruction to inhibit recording (e.g., see Japanese Patent Laid-Open No. 8-161160), commands relating to recording are generally inhibited by executing firmware such that the commands cannot be received, in order to inhibit the recording function of the optical disk device capable of recording.

### DISCLOSURE OF THE INVENTION

In the conventional recording inhibiting method, commands relating to recording are inhibited by firmware such that the commands cannot be received in an optical disk device capable of recording. Thus, unfortunately, when firmware enabling recording has been obtained by a user, that is, when firmware not inhibiting commands relating to recording has been installed, the optical disk device is easily placed in a recordable state.

In another method, updating software operating on a host computer prevents mutual updating of software having a recording function and software not having a recording function. However, these pieces of software generally include the function of forcibly updating software for emergencies, so that the recording function cannot be perfectly inhibited.

The present invention is designed to solve the problems of the prior art. An object of the present invention is to provide a recording operation inhibiting method of a removable medium recording/reproducing device by which the recording function of the removable medium recording/reproducing device, such as an optical disk device originally capable of recording, can be easily inhibited to make it a device for reproducing only, and an optical disk device for reproducing only can be achieved with high security for users while suppressing the cost such as development cost.

In order to solve the problems, a method of inhibiting the recording/reproducing operation of a removable medium recording/reproducing device according to the present invention is a method of inhibiting the recording/reproducing operation of a removable medium recording/reproducing device capable of one of recording and reproduction on multiple kinds of media, the method including: updating firmware limiting the kinds of media on which one of recording and reproduction can be performed in the removable medium recording/reproducing device; and erasing an adjustment value corresponding to a medium on which the recording/reproducing operation is inhibited by the firmware among adjustment values required for performing one of the recording and reproducing operations on the respective kinds of media.

With this method, in the removable medium recording/reproducing device such as an optical disk device originally capable of recording, the firmware for reproducing only is installed to erase information that is necessary for recording and has been stored in a manufacturing/inspection process to obtain the recordable optical disk device. Thus after that, even when firmware enabling recording of data obtained by a user is installed, only the reproducing operation of the optical disk device is enabled and the function of the reproducing operation is limited when necessary.

A method of inhibiting the recording operation of a removable medium recording/reproducing device according to the present invention is a method of inhibiting the recording operation of a removable medium recording/reproducing device capable of one of recording and reproduction on multiple kinds of media, the method including: updating firmware inhibiting the recording operation of the removable medium recording/reproducing device; and erasing the adjustment value by the firmware to inhibit the recording operation.

With this method, in the removable medium recording/reproducing device such as an optical disk device originally capable of recording, the firmware for reproducing only is installed to erase information that is necessary for recording and has been stored in a manufacturing/inspection process to obtain the recordable optical disk device. Thus after that, even when firmware enabling recording of data obtained by a user is installed, only the reproducing operation of the optical disk device can be performed.

A method of inhibiting the recording/reproducing operation of a removable medium recording/reproducing device according to the present invention is a method of inhibiting the recording/reproducing operation of a removable medium recording/reproducing device capable of one of recording and reproduction on multiple kinds of media, the method including: updating firmware limiting the kinds of media on which recording or reproduction can be performed in the removable medium recording/reproducing device; and erasing an adjustment value corresponding to a medium on which the recording/reproducing operation is inhibited by the firmware among adjustment values required for performing one of the recording and reproducing operations on the respective kinds of media, wherein updating the firmware includes: identifying the file size of the firmware to be updated; and updating from the leading end of a firmware storage region by the file size in the removable medium recording/reproducing device, the file size of the firmware to be updated is set larger than the file size of the firmware before updating in consideration of the recording region of the adjustment value corresponding to the medium on which the recording/reproducing operation is inhibited, the recording region being disposed next to the firmware storage region before updating, and the recording region of the adjustment value is overwritten by updating the firmware by the file size, thereby erasing the adjustment value corresponding to the medium on which the recording/reproducing operation is inhibited.

A method of inhibiting the recording/reproducing operation of a removable medium recording/reproducing device according to the present invention is a method of inhibiting the recording/reproducing operation of a removable medium recording/reproducing device capable of one of recording and reproduction on multiple kinds of media, the method including: updating firmware limiting the kinds of media on which one of recording and reproduction can be performed in the removable medium recording/reproducing device; and erasing an adjustment value corresponding to a medium on which the recording/reproducing operation is inhibited by the firmware among adjustment values required for performing the recording or reproducing operations on the respective kinds of media, wherein updating the firmware includes: identifying the file size of the firmware to be updated; updating from the leading end of a firmware storage region by the file size in the removable medium recording/reproducing device; determining a region in which an adjustment value for each kind of media is recorded on a predetermined position relative to the firmware storage region and reading the adjustment value of the recording region as first data; on a predetermined position relative to the body of the firmware in the firmware file to be updated, determining a region corresponding to the recording region of the adjustment value of each kind of medium on which the recording/reproducing operation is inhibited among adjustment values recorded, for the respective kinds of media, on the predetermined position relative to the firmware storage region, and reading, as second data, data recorded in the determined region to decide whether to inhibit the recording/reproducing operation; generating third data by performing a logical operation on the first data and the second data; and writing the third data over the recording region of the adjustment value having been read as the first data for each kind of media, the third data is generated by the logical operation on the first data and the second data such that an adjustment value corresponding to each kind of medium is not kept as the third data when the recording/reproducing operation is inhibited and such that an adjustment value corresponding to each kind of media is kept as the third data when one of the recording and reproducing operations is enabled, and the adjustment value corresponding to the medium on which the recording/reproducing operation is inhibited is erased by writing the third data over the recording region of the adjustment value.

With this method, in the removable medium recording/reproducing device such as an optical disk device originally capable of recording, the firmware for reproducing only is installed to erase information that is necessary for recording and has been stored in a manufacturing/inspection process to obtain the recordable optical disk device. Thus after that, even when firmware enabling recording of data obtained by a user is installed, only the reproducing operation of the optical disk device is enabled and the reproducing operation is limited to inhibit the reproducing function when necessary.

A method of updating the firmware of a removable medium recording/reproducing device according to the present invention is a method of updating the firmware of a removable medium recording/reproducing device capable of one of recording and reproduction on multiple kinds of media, the method including: updating the firmware limiting the kinds of media on which one of recording and reproduction can be performed in the removable medium recording/reproducing device; and erasing an adjustment value corresponding to a medium on which the recording/reproducing operation is inhibited by the firmware among adjustment values required for performing one of recording and reproduction on the respective kinds of media, wherein updating the firmware includes: identifying the file size of the firmware to be updated; and updating from the leading end of a firmware storage region by the file size in the removable medium recording/reproducing device, the file size of the firmware to be updated is set larger than the file size of the firmware before updating in consideration of the recording region of an adjustment value corresponding to a medium on which one of the recording and reproducing operations is inhibited, the recording region being disposed next to the firmware storage region before updating, and the recording region of the adjustment value is overwritten by updating the firmware by the file size, thereby erasing the adjustment value corresponding to the medium on which the recording/reproducing operation is inhibited.

A method of updating the firmware of a removable medium recording/reproducing device according to the present invention is a method of updating the firmware of a removable medium recording/reproducing device capable of one of recording and reproduction on multiple kinds of media, the method including: updating the firmware limiting the kinds of media on which one of recording and reproduction can be performed in the removable medium recording/reproducing device; and erasing an adjustment value corresponding to a medium on which the recording/reproducing operation is inhibited by the firmware among adjustment values required for performing one of the recording and reproducing operations on the respective kinds of media, wherein updating the firmware includes: identifying the file size of the firmware to be updated; and updating from the leading end of a firmware storage region by the file size in the removable medium recording/reproducing device; determining a region in which an adjustment value for each kind of media is recorded on a predetermined position relative to the firmware storage region and reading the adjustment value of the recording region as first data; on a predetermined position relative to the body of the firmware in the firmware file to be updated, determining a region corresponding to the recording region of an adjustment value of each kind of medium on which the recording/reproducing operation is inhibited among adjustment values recorded, for the respective kinds of media, on the predetermined position relative to the firmware storage region, and reading, as second data, data recorded in the determined region to decide whether to inhibit the recording/reproducing operation; generating third data by performing a logical operation on the first data and the second data; and writing the third data over the recording region of the adjustment value having been read as the first data for each kind of media; the third data is generated by the logical operation on the first data and the second data such that an adjustment value corresponding to each kind of medium is not kept as the third data when the recording/reproducing operation is inhibited and such that an adjustment value corresponding to each kind of media is kept as the third data when one of the recording and reproducing operations is enabled, and the adjustment value corresponding to the medium on which the recording/reproducing operation is inhibited is erased by writing the third data over the recording region of the adjustment value.

With this method, in the removable medium recording/reproducing device such as an optical disk device originally capable of recording, the firmware for reproducing only is installed to erase information that is necessary for recording and has been stored in a manufacturing/inspection process to obtain the recordable optical disk device. Thus after that, even when firmware enabling recording of data obtained by a user is installed, only the reproducing operation of the optical disk device is enabled and the reproducing operation is limited to inhibit the reproducing function when necessary.

A file containing the firmware of a removable medium recording/reproducing device according to the present invention is a file containing the firmware of a removable medium recording/reproducing device capable of one of recording and reproduction on multiple kinds of media, the method including: updating the firmware limiting the kinds of media on which one of recording and reproduction can be performed in the removable medium recording/reproducing device; and erasing an adjustment value corresponding to a medium on which the recording/reproducing operation is inhibited by the firmware among adjustment values required for performing one of recording and reproduction on the respective kinds of media, wherein updating the firmware includes: identifying the file size of the firmware to be updated; and updating from the leading end of a firmware storage region by the file size in the removable medium recording/reproducing device, the file size of the firmware to be updated is set larger than the file size of the firmware before updating in consideration of the recording region of an adjustment value corresponding to a medium on which the recording or reproducing operation is inhibited, the recording region being disposed next to the firmware storage region before updating, and the recording region of the adjustment value is overwritten by updating the firmware by the file size, so that the firmware of the removable medium recording/reproducing device is stored to erase the adjustment value corresponding to the medium on which the recording/reproducing operation is inhibited.

A file containing the firmware of a removable medium recording/reproducing device according to the present invention is a file containing the firmware of a removable medium recording/reproducing device capable of one of recording and reproduction on multiple kinds of media, the method including: updating the firmware limiting the kinds of media on which one of recording and reproduction can be performed in the removable medium recording/reproducing device; and erasing an adjustment value corresponding to a medium on which the recording/reproducing operation is inhibited by the firmware among adjustment values required for performing the recording or reproducing operations on the respective kinds of media, wherein updating the firmware includes: identifying the file size of the firmware to be updated; and updating from the leading end of a firmware storage region by the file size in the removable medium recording/reproducing device; determining a region in which an adjustment value for each kind of media is recorded on a predetermined position relative to the firmware storage region and reading the adjustment value of the recording region as first data; on a predetermined position relative to the body of the firmware in the firmware file to be updated, determining a region corresponding to the recording region of an adjustment value of each kind of medium on which the recording/reproducing operation is inhibited among adjustment values recorded, for the respective kinds of media, on the predetermined position relative to the firmware storage region, and reading, as second data, data recorded in the determined region to decide whether to inhibit the recording/reproducing operation; generating third data by performing a logical operation on the first data and the second data; and writing the third data over the recording region of the adjustment value having been read as the first data for each kind of media; the third data is generated by the logical operation on the first data and the second data such that an adjustment value corresponding to each kind of medium is not kept as the third data when the recording/reproducing operation is inhibited and such that an adjustment value corresponding to each kind of media is kept as the third data when one of the recording and reproducing operations is enabled, and the firmware of the removable medium recording/reproducing device is contained such that the adjustment value corresponding to the medium on which the recording/reproducing operation is inhibited is erased by writing the third data over the recording region of the adjustment value.

With this method, in the removable medium recording/reproducing device such as an optical disk device originally capable of recording, the firmware for reproducing only is installed to erase information that is necessary for recording and has been stored in a manufacturing/inspection process to obtain the recordable optical disk device. Thus after that, even when firmware enabling recording of data obtained by a user is installed, only the reproducing operation of the optical disk device is enabled and the reproducing operation is limited to inhibit the reproducing function when necessary.

As described above, according to the present invention, software only capable of reproduction is written while hardware is shared by removable medium recording/reproducing devices, for example, an optical disk device capable of recording and an optical disk device only capable of reproduction, so that only the reproducing function is enabled. Thus even when the software is forcibly updated by a user to enable writing, the writing function cannot be used until the software is adjusted again by a manufacturer in a production/inspection process, so that only the reproducing operation of the optical disk device is enabled. Further, the reproducing operation can be also limited to inhibit the reproducing function when necessary.

Therefore, the recording function of the removable medium recording/reproducing device such as an optical disk device originally capable of recording can be easily inhibited to make it a device for reproducing only, an optical disk device for reproducing only can be achieved with high security for users while suppressing the cost such as development cost, and an optical disk device can be achieved with a reproducing function inhibited when necessary.

### BRIEF DESCRIPTION OF THE DRAWINGS

FIG. 1 is an explanatory drawing showing the operational concept of a typical optical disk device serving as a removable medium recording/reproducing device;

FIG. 2 is an explanatory drawing showing the operational concept for inhibiting the recording or reproducing operation of a removable medium recording/reproducing device according to an embodiment of the present invention;

FIG. 3 is a flowchart showing a method of inhibiting the recording/reproducing operation of a removable medium recording/reproducing device according to a first embodiment of the present invention;

FIG. 4 is a flowchart showing a method of inhibiting the recording/reproducing operation of a removable medium recording/reproducing device according to a fifth embodiment of the present invention;

FIG. 5 is a flowchart showing a method of inhibiting the recording/reproducing operation of a removable medium recording/reproducing device according to a second embodiment of the present invention;

FIG. 6 is a flowchart showing a method of inhibiting the recording/reproducing operation of a removable medium recording/reproducing device according to a sixth embodiment of the present invention;

FIG. 7 is a flowchart showing a method of inhibiting the recording/reproducing operation of a removable medium recording/reproducing device according to a third embodiment of the present invention;

FIG. 8 is a flowchart showing a method of inhibiting the recording/reproducing operation of a removable medium recording/reproducing device according to a seventh embodiment of the present invention;

FIG. 9 is a flowchart showing a method of inhibiting the recording/reproducing operation of a removable medium recording/reproducing device according to a fourth embodiment of the present invention;

FIG. 10 is a flowchart showing a method of inhibiting the recording/reproducing operation of a removable medium recording/reproducing device according to an eighth embodiment of the present invention;

FIG. 11 is a flowchart showing a method of inhibiting the recording/reproducing operation of a removable medium recording/reproducing device according to a ninth embodiment of the present invention;

FIG. 12 is an explanatory drawing showing regions in a flash ROM in the method of inhibiting the recording/reproducing operation of the removable medium recording/reproducing device according to the ninth embodiment;

FIG. 13 is a flowchart showing a method of inhibiting the recording/reproducing operation of a removable medium recording/reproducing device according to a tenth embodiment of the present invention;

FIG. 14 is an explanatory drawing showing regions in a flash ROM in the method of inhibiting the recording/reproducing operation of the removable medium recording/reproducing device according to the tenth embodiment;

FIG. 15 is an explanatory drawing showing recording/reproducing information corresponding to each kind of media in a method of inhibiting the recording/reproducing operation of a removable medium recording/reproducing device according to a twelfth embodiment of the present invention; and

FIG. 16 is an explanatory drawing showing recording/reproducing information corresponding to each kind of media in a method of inhibiting the recording/reproducing operation of a removable medium recording/reproducing device according to an eleventh embodiment of the present invention.

### BEST MODE FOR CARRYING OUT THE INVENTION

The following will specifically describe a method of inhibiting the recording or reproducing operation of a removable medium recording/reproducing device capable of recording or reproduction on multiple kinds of media according to embodiments of the present invention with reference to the accompanying drawings.

First, the following is a basic operational concept of a method of limiting, by executing firmware, the recording or reproducing operation of a typical removable medium recording/reproducing device capable of recording or reproduction on multiple kinds of media (e.g., a rewritable optical disk).

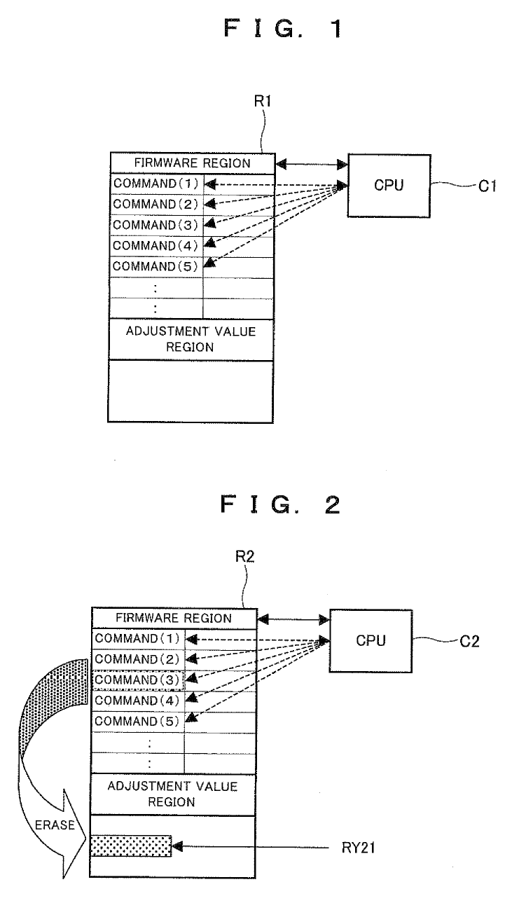

FIG. 1 is an explanatory drawing showing the operational concept of the typical removable medium recording/reproducing device capable of recording or reproduction on multiple kinds of media. FIG. 1 illustrates the relationship between a flash ROM (R1) for storing firmware and a CPU (C1) for performing the commands of the firmware, in the execution of the firmware installed in the removable medium recording/reproducing device capable of recording or reproduction on multiple kinds of media. FIG. 2 is an explanatory drawing showing the operational concept of the method of limiting the recording or reproducing operation of the removable medium recording/reproducing device capable of recording or reproduction on multiple kinds of media according to the present embodiment. FIG. 2 illustrates the relationship between a flash ROM (R2) for storing firmware and a CPU (C2) for performing the commands of the firmware, when the firmware installed in the removable medium recording/reproducing device is executed to erase information required for the recording or reproducing operation in the removable medium recording/reproducing device capable of recording or reproduction on multiple kinds of media.

First, as shown in FIG. 1, the CPU (C1) controls the firmware in a firmware region in the flash ROM (R1) to sequentially perform the commands written in the firmware. The CPU (C1) normally performs the commands from a first command (1) of the firmware immediately after being turned on or reset. The commands are similarly performed also immediately after the firmware is installed, that is, the commands of the firmware are performed by the CPU (C1) after the installation is completed.

Next, as shown in FIG. 2, in the case where the firmware is installed in a firmware region in the flash ROM (R2), the CPU (C2) erases information (e.g., an adjustment value required for recording) in a region RY21 for storing an adjustment value required for the recording or reproducing operation in the flash ROM (R2), in response to, e.g., a command (3) immediately after the installation. Thus the recording or reproducing function cannot be activated in the removable medium recording/reproducing device capable of recording or reproduction on multiple kinds of media.

### FIRST EMBODIMENT

The following is a method of limiting the recording or reproducing operation of a removable medium recording/reproducing device capable of recording or reproduction on multiple kinds of media according to a first embodiment of the present invention.

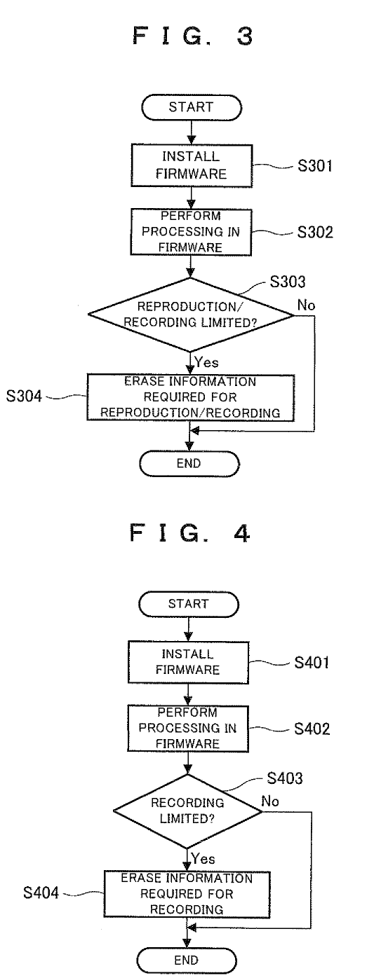

FIG. 3 is a flowchart showing the method of limiting the recording or reproducing operation of the removable medium recording/reproducing device capable of recording or reproduction on multiple kinds of media according to the first embodiment. FIG. 3 illustrates the sequence of erasing information required for the recording or reproducing operation during the installation of firmware.

As shown in FIG. 3, in a production/inspection process, the firmware limiting the recording or reproducing operation on multiple kinds of media is installed in a predetermined region (e.g., a firmware region) in a flash ROM (step S301), program processing in the firmware is performed (step S302), whether or not the firmware limits the recording or reproducing operation in the processing is determined (step S303), and when it is determined that the firmware limits the recording or reproducing operation, information is erased which is written in a predetermined region other than the firmware region in the flash ROM and is necessary for the recording or reproducing operation, the information including an initial value for determining a recording power or an initial value for determining a production power (step S304). When it is determined in step S303 that the firmware does not limit the recording or reproducing operation (recording or reproduction is enabled), the process is completed while keeping the information required for the recording or reproducing operation.

In the method of limiting the recording or reproducing operation of the removable medium recording/reproducing device capable of recording or reproduction on multiple kinds of media according to the first embodiment, the information required for the recording or reproducing operation is erased when the firmware limiting the recording or reproducing operation is downloaded and executed.

### SECOND EMBODIMENT

The following is a method of limiting the recording or reproducing operation of a removable medium recording/reproducing device capable of recording or reproduction on multiple kinds of media according to a second embodiment of the present invention.

In the method of limiting the recording or reproducing operation of the removable medium recording/reproducing device capable of recording or reproduction on multiple kinds of media according to the second embodiment, information required for the recording or reproducing operation is erased by receiving a special command. In other words, in the removable medium recording/reproducing device capable of recording or reproduction on multiple kinds of media, a special command is prepared in addition to commands normally used for performing functions relating to recording or reproduction, and information required for the recording or reproducing operation is erased at the reception of the special command.

FIG. 5 is a flowchart showing the method of limiting the recording or reproducing operation of the removable medium recording/reproducing device capable of recording or reproduction on multiple kinds of media according to the second embodiment. FIG. 5 illustrates the sequence of erasing the information required for the recording or reproducing operation at the reception of the special command.

As shown in FIG. 5, in the removable medium recording/reproducing device capable of recording or reproduction on multiple kinds of media, the special command other than the commands normally used for performing functions relating to recording or reproduction is received from, e.g., a host computer in a production/inspection process (step S501), it is determined whether or not the received special command limits the recording or reproducing operation at that time (step S502), and when it is determined that the special command limits the recording or reproducing operation, information is erased which is written in a predetermined region other than a firmware region in a flash ROM and is necessary for recording or reproduction, the information including an initial value for determining a recording power or an initial value for determining a production power (step S503). When it is determined in step S502 that the special command does not limit the recording or reproducing operation (recording or reproduction is enabled), the process is completed while keeping the information required for the recording or reproducing operation.

In the method of limiting the recording or reproducing operation of the removable medium recording/reproducing device capable of recording or reproduction on multiple kinds of media according to the second embodiment, the information required for the recording or reproducing operation is erased at the reception of the special command in firmware for limiting the recording or reproducing operation.

### THIRD EMBODIMENT

The following is a method of limiting the recording or reproducing operation of a removable medium recording/reproducing device capable of recording or reproduction on multiple kinds of media according to a third embodiment of the present invention.

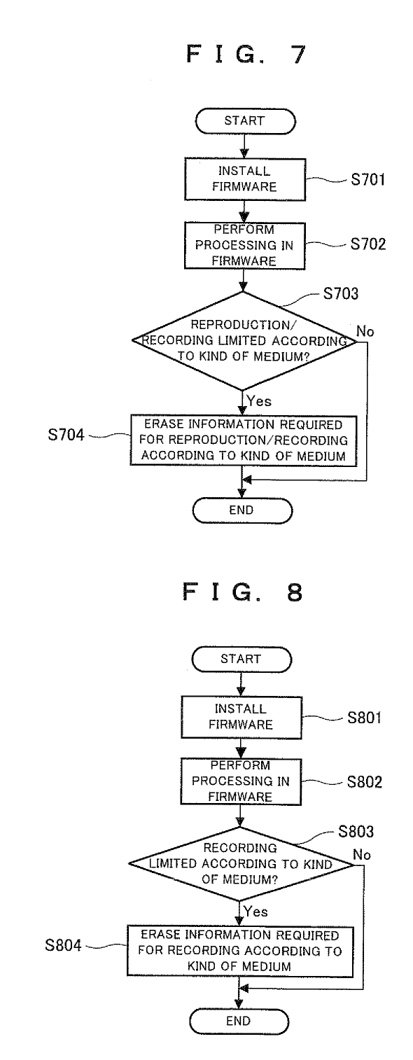

FIG. 7 is a flowchart showing the method of limiting the recording or reproducing operation of the removable medium recording/reproducing device capable of recording or reproduction on multiple kinds of media according to the third embodiment. FIG. 7 illustrates the sequence of identifying the kind of limited medium and erasing information required for a recording or reproducing operation corresponding to the identified medium, during the installation of firmware.

As shown in FIG. 7, in a production/inspection process, the firmware is installed in a predetermined region (e.g., a firmware region) in a flash ROM, the firmware including a program for identifying the kind of medium and limiting the recording or reproducing function so as to disable the recording or reproducing operation of the identified medium (step S701), program processing in the firmware is performed (step S702), it is determined whether or not the firmware limits the recording or reproducing operation according to a kind of medium in the processing (step S703), and when it is determined that the firmware limits the recording or reproducing operation according to a kind of medium, information necessary for the recording or reproducing operation of the limited kind of medium is erased, for example, an initial value for determining a recording power or an initial value for determining a production power is erased out of information that is written in a predetermined region other than the firmware region in the flash ROM and is necessary for the recording or reproducing operation (step S704). When it is determined in step S703 that the firmware does not limit the recording or reproducing operation (recording or reproduction is enabled) of any kind of medium, the process is completed while keeping the information required for the recording or reproducing operation.

In the method of limiting the recording or reproducing operation of the removable medium recording/reproducing device capable of recording or reproduction on multiple kinds of media according to the third embodiment, the information required for the recording or reproducing operation is erased when the firmware limiting the recording or reproducing operation is downloaded and executed.

### FOURTH EMBODIMENT

The following is a method of limiting the recording or reproducing operation of a removable medium recording/reproducing device capable of recording or reproduction on multiple kinds of media according to a fourth embodiment of the present invention.

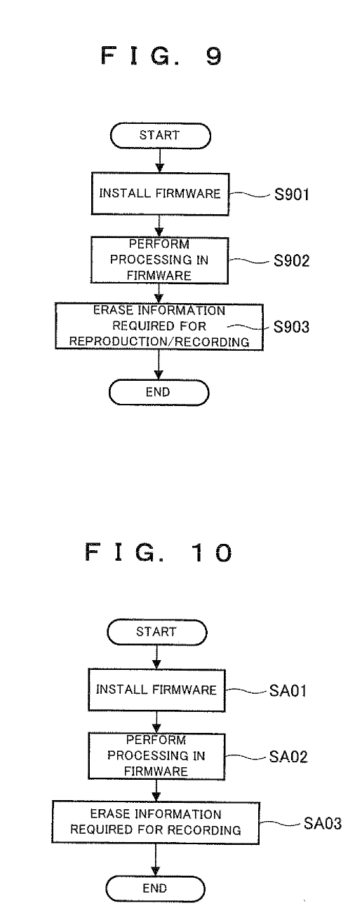

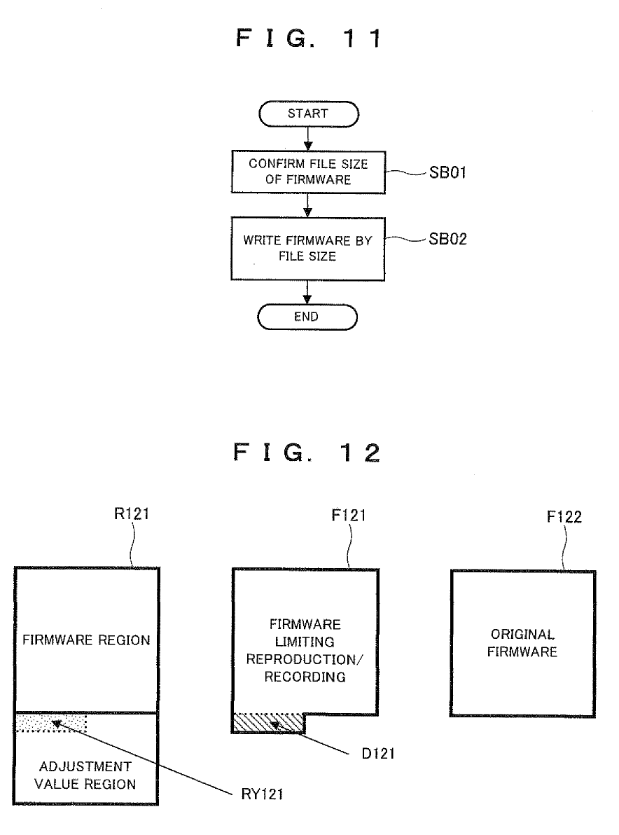

FIG. 9 is a flowchart showing the method of limiting the recording or reproducing operation of the removable medium recording/reproducing device capable of recording or reproduction on multiple kinds of media according to the fourth embodiment. FIG. 9 illustrates the sequence of erasing information required for the recording or reproducing operation during the installation of firmware.

As shown in FIG. 9, in a production/inspection process, the firmware is installed in a predetermined region (e.g., a firmware region) in a flash ROM, the firmware including a program limiting the recording or reproducing function so as to disable the recording or reproducing operations on multiple kinds of media (step S901), program processing in the firmware is performed (step S902), and in this processing, information is forcibly erased which is written in a predetermined region other than the firmware region in the flash ROM and is necessary for the recording or reproducing operation, the information including an initial value for determining a recording power or an initial value for determining a production power (step S903).

In the method of limiting the recording or reproducing operation of the removable medium recording/reproducing device capable of recording or reproduction on multiple kinds of media according to the fourth embodiment, the information required for the recording or reproducing operation is forcibly erased when the firmware limiting the recording or reproducing operation is downloaded and executed.

### FIFTH EMBODIMENT

The following is a method of limiting the recording operation of a removable medium recording/reproducing device capable of recording or reproduction on multiple kinds of media according to a fifth embodiment of the present invention.

FIG. 4 is a flowchart showing the method of limiting the recording operation of the removable medium recording/reproducing device capable of recording or reproduction on multiple kinds of media according to the fifth embodiment. FIG. 4 illustrates the sequence of erasing information required for the recording operation during the installation of firmware.

As shown in FIG. 4, in a production/inspection process, the firmware is installed in a predetermined region (e.g., a firmware region) in a flash ROM, the firmware including a program limiting the recording function so as to disable the recording operations on multiple kinds of media (step S401), program processing in the firmware is performed (step S402), whether or not the firmware limits the recording operation is determined by the processing (step S403), and when it is determined that the firmware limits the recording operation, information is erased which is written in a predetermined region other than the firmware region in the flash ROM and is necessary for the recording operation, the information including an initial value for determining a recording power (step S404). When it is determined in step S403 that the firmware does not limit the recording operation (recording is enabled), the process is completed while keeping the information required for the recording operation.

In the method of the fifth embodiment, the information required for the recording operation is erased when the firmware limiting the recording operation is downloaded and executed.

### SIXTH EMBODIMENT

The following is a method of limiting the recording operation of a removable medium recording/reproducing device capable of recording or reproduction on multiple kinds of media according to a sixth embodiment of the present invention.

In the method of limiting the recording operation of the removable medium recording/reproducing device capable of recording or reproduction on multiple kinds of media according to the sixth embodiment, information required for the recording operation is erased by receiving a special command. In other words, in the removable medium recording/reproducing device capable of recording or reproduction on multiple kinds of media, a special command is prepared in addition to commands normally used for performing functions relating to recording or reproduction and information required for the recording operation is erased at the reception of the special command.

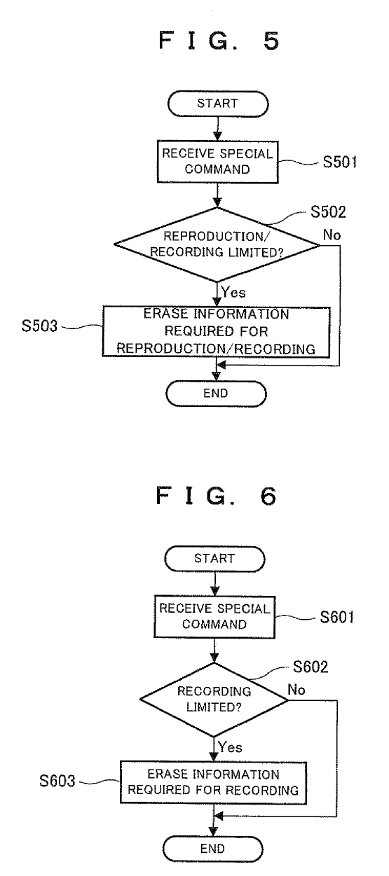

FIG. 6 is a flowchart showing the method of limiting the recording operation of the removable medium recording/reproducing device capable of recording or reproduction on multiple kinds of media according to the sixth embodiment. FIG. 6 illustrates the sequence of erasing the information required for the recording operation at the reception of the special command.

As shown in FIG. 6, in the removable medium recording/reproducing device capable of recording or reproduction on multiple kinds of media, the special command other than commands normally used for performing functions relating to recording or reproduction is received from, e.g., a host computer in a production/inspection process (step S601), it is determined whether or not the received special command limits the recording operation at that time (step S602), and when it is determined that the special command limits the recording operation, information is erased which is written in a predetermined region other than a firmware region in a flash ROM and is necessary for the recording operation, the information including an initial value for determining a recording power (step S603). When it is determined in step S602 that the special command does not limit the recording operation (recording is enabled), the process is completed while keeping the information required for the recording operation.

In the method of limiting the recording operation of the removable medium recording/reproducing device capable of recording or reproduction on multiple kinds of media according to the sixth embodiment, the information required for the recording operation is erased at the reception of the special command in firmware limiting the recording operation.

### SEVENTH EMBODIMENT

The following is a method of limiting the recording operation of a removable medium recording/reproducing device capable of recording or reproduction on multiple kinds of media according to a seventh embodiment of the present invention.

FIG. 8 is a flowchart showing the method of limiting the recording operation of the removable medium recording/reproducing device capable of recording or reproduction on multiple kinds of media according to the seventh embodiment. FIG. 8 illustrates the sequence of identifying the kind of limited medium and erasing information required for a recording operation corresponding to the identified medium during the installation of firmware.

As shown in FIG. 8, in a production/inspection process, the firmware is installed in a predetermined region (e.g., a firmware region) in a flash ROM, the firmware including a program for identifying the kind of medium and limiting the recording function so as to disable the recording operation of the identified medium (step S801), program processing in the firmware is performed (step S802), it is determined whether or not the firmware limits the recording operation of a kind of medium in the processing (step S803), and when it is determined that the firmware limits the recording operation of a kind of medium, information necessary for the recording operation of the limited kind of medium is erased, for example, an initial value for determining a recording power is erased out of information that is written in a predetermined region other than the firmware region in the flash ROM and is necessary for the recording operation (step S804). When it is determined in step S803 that the firmware does not limit the recording operation (recording is enabled) of any kind of medium, the process is completed while keeping the information required for the recording operation.

In the method of limiting the recording operation of the removable medium recording/reproducing device capable of recording or reproduction on multiple kinds of media according to the seventh embodiment, the information required for the recording operation is erased when the firmware limiting the recording operation is downloaded and executed.

### EIGHTH EMBODIMENT

The following is a method of limiting the recording operation of a removable medium recording/reproducing device capable of recording or reproduction on multiple kinds of media according to an eighth embodiment of the present invention.

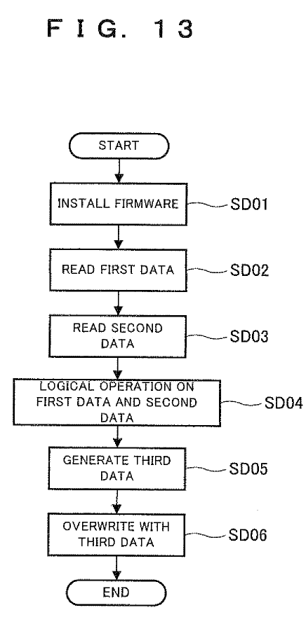

FIG. 10 is a flowchart showing the method of limiting the recording operation of the removable medium recording/reproducing device capable of recording or reproduction on multiple kinds of media according to the eighth embodiment. FIG. 10 illustrates the sequence of erasing information required for the recording operation during the Installation of firmware.

As shown in FIG. 10, in a production/inspection process, the firmware is installed in a predetermined region (e.g., a firmware region) in a flash ROM, the firmware including a program limiting the recording function so as to disable the recording operations on multiple kinds of media (step SA01), program processing in the firmware is performed (step SA02), and in this processing, information is forcibly erased which is written in a predetermined region other than the firmware region in the flash ROM and is necessary for the recording operation, the information including an initial value for determining a recording power (step SA03).

In the method of limiting the recording operation of the removable medium recording/reproducing device capable of recording or reproduction on multiple kinds of media according to the eighth embodiment, the information required for the recording operation is forcibly erased when the firmware limiting the recording operation is downloaded and executed.

### NINTH EMBODIMENT

The following is a method of limiting the recording or reproducing operation of a removable medium recording/reproducing device capable of recording or reproduction on multiple kinds of media according to a ninth embodiment of the present invention.

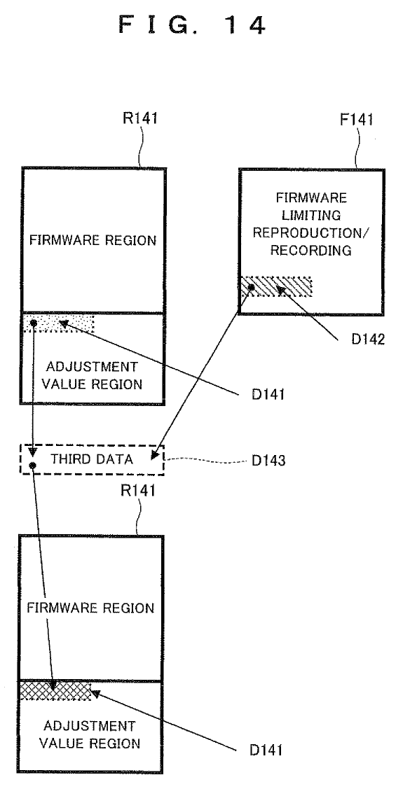

FIG. 11 is a flowchart showing a method of installing firmware in the removable medium recording/reproducing device capable of recording or reproduction on multiple kinds of media according to the ninth embodiment FIG. 12 shows a firmware region serving as a predetermined region where the firmware is installed in a flash ROM, in the removable medium recording/reproducing device capable of recording or reproduction on multiple kinds of media according to the ninth embodiment.

In the method of installing the firmware in the predetermined region (e.g., the firmware region) in the flash ROM, as shown in FIG. 11, the file size of the firmware to be installed is identified and confirmed in a production/inspection process (step SB01) and the file of the firmware to be installed is written from the leading end of the firmware region in the flash ROM only by the file size (step SB02).

In this case, as shown in FIG. 12, in order to limit the recording or reproducing operation, the firmware (firmware file F121) that limits reproduction/recording and is to be installed in a flash ROM R121 for updating has a file size set larger than the size of the original firmware (firmware file F122) before updating, so that the firmware for updating in the firmware file P121 is written over information required for the recording or reproducing operation and stored in a region RY121 and the information is erased by erase data D121 for invalidating the information required for reproduction/recording. The region RY121 is provided immediately after the firmware region of the flash ROM R121 to store the information required for reproduction/recording. In the case of the original firmware, that is, when recording or reproduction is not limited, the firmware file F121 has a file size equal to the firmware region in the flash ROM R121 and the process is completed while keeping the information required for the recording or reproducing operation.

### TENTH EMBODIMENT

The following is a method of limiting the recording or reproducing operation of a removable medium recording/reproducing device capable of recording or reproduction on multiple kinds of media according to a tenth embodiment of the present invention.

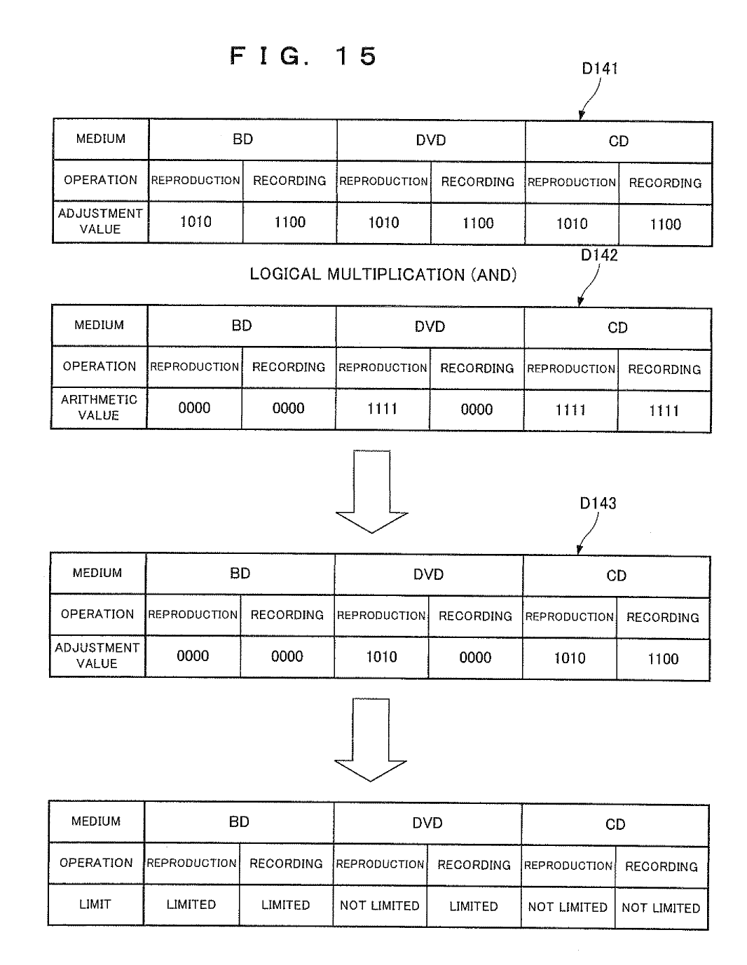

FIG. 13 is a flowchart showing a method of installing firmware in the removable medium recording/reproducing device capable of recording or reproduction on multiple kinds of media according to the tenth embodiment. FIG. 14 shows a firmware region for installing the firmware in a flash ROM R141, an adjustment value region for storing information required for a recording or reproducing operation, and a firmware file F141 for limiting the recording or reproducing operation, in the removable medium recording/reproducing device capable of recording or reproduction on multiple kinds of media according to the tenth embodiment.

As shown in FIG. 13, in a production/inspection process, when the firmware for limiting the recording or reproducing operation is installed in a predetermined region (e.g., the firmware region) in the flash ROM, the size of the firmware file to be installed is identified at that time and the firmware file is written from the leading end of the firmware region in the flash ROM by the file size, so that the firmware is installed (step SD01), the adjustment value region for recording an adjustment value for each kind of media is determined on a predetermined position in a region other than the firmware region in the flash ROM, and an adjustment value serving as information required for recording or reproduction on a kind of media is read as first data D141 from the adjustment value region (step SD02), on a predetermined position relative to the body of the firmware in the firmware file installed for updating, a region is determined which corresponds to the recording region of an adjustment value of each kind of medium on which the recording or reproducing operation is limited and inhibited among adjustment values recorded, for the respective kinds of media, on the predetermined position other than the firmware region in the flash ROM, and data recorded in the determined region to decide whether to limit and inhibit the recording or reproducing operation is read as second data D142 (step SD03), a logical operation is performed on the read first data and second data (step SD04), when the recording or reproducing operation is limited and inhibited, the information required for the recording or reproducing operation is not kept, when the recording or reproducing operation is not limited or inhibited, third data D143 is generated which includes data for keeping the information required for the recording or reproducing operation (step SD05), and the generated third data including the information required for the recording or reproducing operation is written over the first data allocated in the adjustment value region for storing, in the flash ROM, the information required for the recording or reproducing operation on each kind of media.

### ELEVENTH EMBODIMENT

The following is a method of limiting the recording or reproducing operation of a removable medium recording/reproducing device capable of recording or reproduction on multiple kinds of media according to an eleventh embodiment of the present invention.

As shown in FIG. 16, in second data D142 indicating information for determining whether to limit the recording or reproducing operation in firmware to be installed, all bits are set to 1 in regions corresponding to medium types on which recording or reproducing operations are limited, and all bits are set to 0 in regions corresponding to medium types on which recording or reproducing operations are not limited. A logical OR is performed on the second data and first data D141 allocated in an adjustment value region for storing, in a flash ROM, information required for the recording or reproducing operation on each kind of medium, so that third data D143 is generated. The generated third data is written over a region for storing, in the adjustment value region in the flash ROM, information required for the recording or reproducing operation on each kind of media.

### TWELFTH EMBODIMENT

The following is a method of limiting the recording or reproducing operation of a removable medium recording/reproducing device capable of recording or reproduction on multiple kinds of media according to a twelfth embodiment of the present invention.

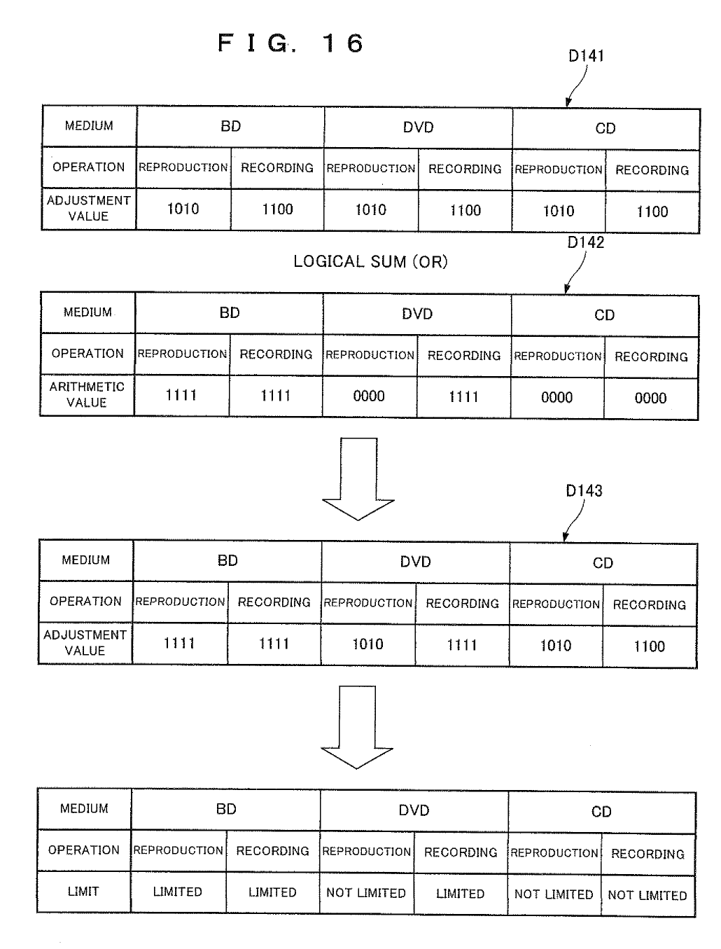

As shown in FIG. 15, in second data D142 indicating information for determining whether to limit the recording or reproducing operation in firmware to be installed, all bits are set to 0 in regions corresponding to medium types on which recording or reproducing operations are limited, and all bits are set to 1 in regions corresponding to medium types on which recording or reproducing operations are not limited. A logical AND is performed on the second data and first data D141 allocated in an adjustment value region for storing, in a flash ROM, information required for the recording or reproducing operation on each kind of medium, so that third data D143 is generated. The generated third data is written over a region for storing, in the adjustment value region in the flash ROM, information required for the recording or reproducing operation on each kind of media.

### INDUSTRIAL APPLICABILITY

In a method of inhibiting the recording/reproducing operation of a removable medium recording/reproducing device according to the present invention, the recording function of the removable medium recording/reproducing device such as an optical disk device originally capable of recording can be easily inhibited to make it a device for reproducing only, an optical disk device for reproducing only can be achieved with high security for users while suppressing the cost such as development cost, and an optical disk device can be achieved with a reproducing function inhibited when necessary. This method is applicable when the recording function of an optical disk device capable of recording is inhibited to change the device to an optical disk device for reproducing only and when the reproducing function is inhibited when necessary.

This application is based upon and claims the benefit of priority of Japanese Patent Application No. 2005-189081 filed on Jun. 29, 2005, the contents of which is incorporated herein by references in its entirety.

1. A method of inhibiting a recording/reproducing operation of a removable medium recording/reproducing device capable of one of recording and reproduction on multiple kinds of media, the method comprising:
updating firmware limiting the kinds of media on which one of recording and reproduction can be performed in the removable medium recording/reproducing device; and
erasing an adjustment value corresponding to a medium on which a recording/reproducing operation is inhibited by the firmware among adjustment values required for performing one of the recording and reproducing operations on the respective kinds of media.

2. The method of inhibiting a recording/reproducing operation of a removable medium recording/reproducing device according to claim 1, wherein the erasing of the adjustment value is performed when a special command indicating erasure of the adjustment value is received in addition to an ordinary command used in the removable medium recording/reproducing device.

3. The method of inhibiting a recording/reproducing operation of a removable medium recording/reproducing device according to claim 1, wherein the erasing of the adjustment value comprises: when the updated firmware is executed in the removable medium recording/reproducing device, identifying, by means of the firmware, the kind of media on which the recording/reproducing operation is inhibited; and
erasing only the adjustment value corresponding to the medium on which the recording/reproducing operation is inhibited.

4. The method of inhibiting a recording/reproducing operation of a removable medium recording/reproducing device according to claim 1, wherein the adjustment value is forcibly erased when the updated firmware is executed in the removable medium recording/reproducing device.

5. A method of inhibiting a recording operation of a removable medium recording/reproducing device capable of one of recording and reproduction on multiple kinds of media, the method comprising:
updating firmware inhibiting the recording operation of the removable medium recording/reproducing device; and
erasing the adjustment value by the firmware to inhibit the recording operation.

6. The method of inhibiting a recording operation of a removable medium recording/reproducing device according to claim 5, wherein the erasing of the adjustment value is performed when a special command indicating erasure of the adjustment value is received in addition to an ordinary command used in the removable medium recording/reproducing device.

7. The method of inhibiting a recording operation of a removable medium recording/reproducing device according to claim 5, wherein the erasing of the adjustment value comprises: when the updated firmware is executed in the removable medium recording/reproducing device, determining, by means of the firmware, whether the recording operation is inhibited; and
erasing the adjustment value only when the recording operation is inhibited.

8. The method of inhibiting a recording operation of a removable medium recording/reproducing device according to claim 5, wherein the adjustment value is forcibly erased when the updated firmware is executed in the removable medium recording/reproducing device.

9. A method of inhibiting a recording/reproducing operation of a removable medium recording/reproducing device capable of one of recording and reproduction on multiple kinds of media, the method comprising:
updating firmware limiting the kinds of media on which one of recording and reproduction can be performed in the removable medium recording/reproducing device; and
erasing an adjustment value corresponding to a medium on which a recording/reproducing operation is inhibited by the firmware among adjustment values required for performing one of the recording and reproducing operations on the respective kinds of media,
wherein updating the firmware comprises:
identifying a file size of the firmware to be updated; and
updating from a leading end of a firmware storage region by the file size in the removable medium recording/reproducing device,
the file size of the firmware to be updated is set larger than a file size of the firmware before updating in consideration of a recording region of the adjustment value corresponding to the medium on which the recording/reproducing operation is inhibited, the recording region being disposed next to the firmware storage region before updating, and
the recording region of the adjustment value is overwritten by updating the firmware by the file size, thereby erasing the adjustment value corresponding to the medium on which the recording/reproducing operation is inhibited.

10. A method of inhibiting a recording/reproducing operation of a removable medium recording/reproducing device capable of one of recording and reproduction on multiple kinds of media, the method comprising:
updating firmware limiting the kinds of media on which one of recording and reproduction can be performed in the removable medium recording/reproducing device; and
erasing an adjustment value corresponding to a medium on which a recording/reproducing operation is inhibited by the firmware among adjustment values required for performing one of the recording and reproducing operations on the respective kinds of media,
wherein updating the firmware comprises:
identifying a file size of the firmware to be updated;
updating from a leading end of a firmware storage region by the file size in the removable medium recording/reproducing device;
determining a region in which an adjustment value for each kind of media is recorded on a predetermined position relative to the firmware storage region and reading the adjustment value of the recording region as first data;
on a predetermined position relative to a body of the firmware in the firmware file to be updated,
determining a region corresponding to a recording region of the adjustment value of each kind of medium on which the recording/reproducing operation is inhibited among adjustment values recorded, for the respective kinds of media, on the predetermined position relative to the firmware storage region, and reading, as second data, data recorded in the determined region to decide whether to inhibit the recording/reproducing operation;
generating third data by performing a logical operation on the first data and the second data; and
writing the third data over the recording region of the adjustment value having been read as the first data for each kind of media,
the third data is generated by the logical operation on the first data and the second data such that an adjustment value corresponding to each kind of medium is not kept as the third data when the recording/reproducing operation is inhibited and such that an adjustment value corresponding to each kind of media is kept as the third data when one of the recording and reproducing operations is enabled, and
the adjustment value corresponding to the medium on which the recording/reproducing operation is inhibited is erased by writing the third data over the recording region of the adjustment value.

11. The method of inhibiting a recording/reproducing operation of a removable medium recording/reproducing device according to claim 10, wherein in the second data, all bits are set to 1 in a region corresponding to the recording region of the adjustment value corresponding to the medium on which the recording/reproducing operation is inhibited, and
all bits are set to 0 in a region corresponding to the recording region of the adjustment value corresponding to the medium on which one of recording and reproduction is enabled, and
the third data is generated by performing a logical OR on the first data and the second data.

12. The method of inhibiting a recording/reproducing operation of a removable medium recording/reproducing device according to claim 10, wherein in the second data, all bits are set to 0 in a region corresponding to the recording region of the adjustment value corresponding to the medium on which the recording/reproducing operation is inhibited, and
all bits are set to 1 in a region corresponding to the recording region of the adjustment value corresponding to the medium on which one of recording and reproduction is enabled, and
the third data is generated by performing a logical AND on the first data and the second data.

13. A method of updating firmware of a removable medium recording/reproducing device capable of one of recording and reproduction on multiple kinds of media, the method comprising:
updating the firmware limiting the kinds of media on which one of recording and reproduction can be performed in the removable medium recording/reproducing device; and
erasing an adjustment value corresponding to a medium on which a recording/reproducing operation is inhibited by the firmware among adjustment values required for performing one of the recording and reproducing operations on the respective kinds of media,
wherein updating the firmware comprises:
identifying a file size of the firmware to be updated; and
updating from a leading end of a firmware storage region by the file size in the removable medium recording/reproducing device,
the file size of the firmware to be updated is set larger than a file size of the firmware before updating in consideration of a recording region of the adjustment value corresponding to the medium on which the recording/reproducing operation is inhibited, the recording region being disposed next to the firmware storage region before updating, and
the recording region of the adjustment value is overwritten by updating the firmware by the file size, thereby erasing the adjustment value corresponding to the medium on which the recording/reproducing operation is inhibited.

14. A method of updating firmware of a removable medium recording/reproducing device capable of one of recording and reproduction on multiple kinds of media, the method comprising:
updating the firmware limiting the kinds of media on which one of recording and reproduction can be performed in the removable medium recording/reproducing device; and
erasing an adjustment value corresponding to a medium on which a recording/reproducing operation is inhibited by the firmware among adjustment values required for performing one of the recording and reproducing operations on the respective kinds of media,
wherein updating the firmware comprises:
identifying a file size of the firmware to be updated; and
updating from a leading end of a firmware storage region by the file size in the removable medium recording/reproducing device;
determining a region in which an adjustment value for each kind of media is recorded on a predetermined position relative to the firmware storage region and reading the adjustment value of the recording region as first data;
on a predetermined position relative to a body of the firmware in the firmware file to be updated, determining a region corresponding to a recording region of the adjustment value of each kind of medium on which the recording/reproducing operation is inhibited among adjustment values recorded, for the respective kinds of media, on the predetermined position relative to the firmware storage region, and reading, as second data, data recorded in the determined region to decide whether to inhibit the recording/reproducing operation;
generating third data by performing a logical operation on the first data and the second data; and
writing the third data over the recording region of the adjustment value having been read as the first data for each kind of media,
the third data is generated by the logical operation on the first data and the second data such that an adjustment value corresponding to each kind of medium is not kept as the third data when the recording/reproducing operation is inhibited and such that an adjustment value corresponding to each kind of media is kept as the third data when one of the recording and reproducing operations is enabled, and
the adjustment value corresponding to the medium on which the recording/reproducing operation is inhibited is erased by writing the third data over the recording region of the adjustment value.

15. The method of updating firmware of a removable medium recording/reproducing device according to claim 14, wherein in the second data, all bits are set to 1 in a region corresponding to the recording region of the adjustment value corresponding to the medium on which the recording/reproducing operation is inhibited, and
all bits are set to 0 in a region corresponding to the recording region of the adjustment value corresponding to the medium on which one of recording and reproduction is enabled, and
the third data is generated by performing a logical OR on the first data and the second data.

16. The method of updating firmware of a removable medium recording/reproducing device according to claim 14, wherein in the second data, all bits are set to 0 in a region corresponding to the recording region of the adjustment value corresponding to the medium on which the recording/reproducing operation is inhibited, and
all bits are set to 1 in a region corresponding to the recording region of the adjustment value corresponding to the medium on which one of recording and reproduction is enabled, and
the third data is generated by performing a logical AND on the first data and the second data.

17. A file containing firmware of a removable medium recording/reproducing device capable of one of recording and reproduction on multiple kinds of media, the method comprising:
updating the firmware limiting the kinds of media on which one of recording and reproduction can be performed in the removable medium recording/reproducing device; and
erasing an adjustment value corresponding to a medium on which a recording/reproducing operation is inhibited by the firmware among adjustment values required for performing one of recording and reproduction on the respective kinds of media,
wherein updating the firmware comprises:
identifying a file size of the firmware to be updated; and
updating from a leading end of a firmware storage region by the file size in the removable medium recording/reproducing device,
the file size of the firmware to be updated is set larger than a file size of the firmware before updating in consideration of a recording region of the adjustment value corresponding to the medium on which the recording/reproducing operation is inhibited, the recording region being disposed next to the firmware storage region before updating, and
the recording region of the adjustment value is overwritten by updating the firmware by the file size, thereby erasing the adjustment value corresponding to the medium on which the recording/reproducing operation is inhibited.

18. A file containing firmware of a removable medium recording/reproducing device capable of one of recording and reproduction on multiple kinds of media, the method comprising:
updating the firmware limiting the kinds of media on which one of recording and reproduction can be performed in the removable medium recording/reproducing device; and
erasing an adjustment value corresponding to a medium on which a recording/reproducing operation is inhibited by the firmware among adjustment values required for performing one of recording and reproduction on the respective kinds of media,
wherein updating the firmware comprises:
identifying a file size of the firmware to be updated; and
updating from a leading end of a firmware storage region by the file size in the removable medium recording/reproducing device;
determining a region in which an adjustment value for each kind of media is recorded on a predetermined position relative to the firmware storage region and reading the adjustment value of the recording region as first data;
on a predetermined position relative to a body of the firmware in the firmware file to be updated, determining a region corresponding to a recording region of an adjustment value of each kind of medium on which the recording/reproducing operation is inhibited among adjustment values recorded, for the respective kinds of media, on the predetermined position relative to the firmware storage region, and reading, as second data, data recorded in the determined region to decide whether to inhibit the recording/reproducing operation;
generating third data by performing a logical operation on the first data and the second data; and
writing the third data over the recording region of the adjustment value having been read as the first data for each kind of media;
the third data is generated by the logical operation on the first data and the second data such that an adjustment value corresponding to each kind of medium is not kept as the third data when the recording/reproducing operation is inhibited and such that an adjustment value corresponding to each kind of media is kept as the third data when one of the recording and reproducing operations is enabled, and
the adjustment value corresponding to the medium on which the recording/reproducing operation is inhibited is erased by writing the third data over the recording region of the adjustment value.

19. The file containing firmware of a removable medium recording/reproducing device according to claim 18, wherein in the second data, all bits are set to 1 in a region corresponding to the recording region of the adjustment value corresponding to the medium on which the recording/reproducing operation is inhibited, and
all bits are set to 0 in a region corresponding to the recording region of the adjustment value corresponding to the medium on which one of recording and reproduction is enabled, and
the third data is generated by performing a logical OR on the first data and the second data.

20. The file containing firmware of a removable medium recording/reproducing device according to claim 18, wherein in the second data, all bits are set to 0 in a region corresponding to the recording region of the adjustment value corresponding to the medium on which the recording/reproducing operation is inhibited, and
all bits are set to 1 in a region corresponding to the recording region of the adjustment value corresponding to the medium on which one of recording and reproduction is enabled, and
the third data is generated by performing a logical AND on the first data and the second data.
